(19) United States
(12) Patent Application Publication
(10) Pub. No.: US 2021/0384733 A1
(43) Pub. Date: Dec. 9, 2021

(54) POWER CONDITIONING SYSTEM, CONTROL DEVICE AND CONTROL METHOD

(71) Applicant: KABUSHIKI KAISHA YASKAWA DENKI, Kitakyushu-shi (JP)

(72) Inventor: Toshiaki KUSHIHARA, Kitakyushu-shi (JP)

(73) Assignee: KABUSHIKI KAISHA YASKAWA DENKI, Kitakyushu-shi (JP)

(21) Appl. No.: 17/333,178

(22) Filed: May 28, 2021

(30) Foreign Application Priority Data
Jun. 3, 2020 (JP) 2020-096952

(51) Int. Cl. H02J 3/38; H02J 7/35; H02J 7/00

(52) U.S. Cl. CPC H02J 3/381; H02J 2300/24; H02J 7/0068; H02J 7/35

(57) ABSTRACT

A power conditioning system includes a DC/AC converter connected to a DC line to which DC power from a solar panel is output such that the DC/AC converter converts the DC power to AC power and output the AC power, a storage battery that is connected to the DC line and stores the DC power, and a control circuit that calculates a charging output based on a charging current between the DC line and the storage battery and on a voltage of the storage battery, and causes an output of the DC/AC converter to correspond to the charging output.

### CROSS-REFERENCE TO RELATED APPLICATIONS

The present application is based upon and claims the benefit of priority to Japanese Patent Application No. 2020-096952, filed Jun. 3, 2020, the entire contents of which are incorporated herein by reference.

### BACKGROUND OF THE INVENTION

### Field of the Invention

The present disclosure relates to a power conditioning system, a control device and a control method.

### Description of Background Art

Japanese Patent Application Laid-Open Publication No. 2019-205309 describes a power supply system that includes: a charging and discharging controller that controls a voltage and a current output by a solar panel; a bidirectional DC/DC converter that converts a level of a DC current output from the charging and discharging controller and supplies the result of the conversion to a storage battery; and an inverter that converts DC power from the charging and discharging controller and the bidirectional DC/DC converter to AC power. The entire contents of this publication are incorporated herein by reference.

### SUMMARY OF THE INVENTION

According to one aspect of the present invention, a power conditioning system includes a DC/AC converter connected to a DC line to which DC power from a solar panel is output such that the DC/AC converter converts the DC power to AC power and output the AC power, a storage battery that is connected to the DC line and stores the DC power, and a control circuit that calculates a charging output based on a charging current between the DC line and the storage battery and on a voltage of the storage battery, and causes an output of the DC/AC converter to correspond to the charging output.

According to another aspect of the present invention, a control method implemented by a control device includes calculating a charging output based on a charging current between a DC line and a storage battery and on a voltage of the storage battery, and causing an output of a DC/AC converter to correspond to the charging output. The storage battery is connected to the DC line to which DC power from a solar panel is input, the storage battery stores the DC power, and the DC/AC converter is connected to the DC line and converts the DC power to AC power and to output the AC power.

According to yet another aspect of the present invention, a control device includes a control circuit that calculates a charging output based on a charging current input into a storage battery and on a voltage of the storage battery, and causes an output of a DC/AC converter to correspond to the charging output. The storage battery is connected to a DC line to which DC power from a solar panel is input such that the storage battery stores the DC power, and the DC/AC converter is connected to the DC line and converts the DC power to AC power and to output the AC power.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic diagram illustrating a structure of a power conditioning system;

FIG. 2 is a block diagram illustrating a hardware structure of a control device;

FIG. 3 is a flowchart illustrating a charging control procedure;

FIG. 4 is a flowchart illustrating a constant current charging control procedure;

FIG. 5 is a flowchart illustrating a constant voltage charging control procedure;

FIG. 6 is a flowchart illustrating an output control procedure; and

FIG. 7 is a flowchart illustrating a discharging control procedure.

### DETAILED DESCRIPTION OF THE EMBODIMENTS

Embodiments will now be described with reference to the accompanying drawings, wherein like reference numerals designate corresponding or identical elements throughout the various drawings.

### Power Conditioning System

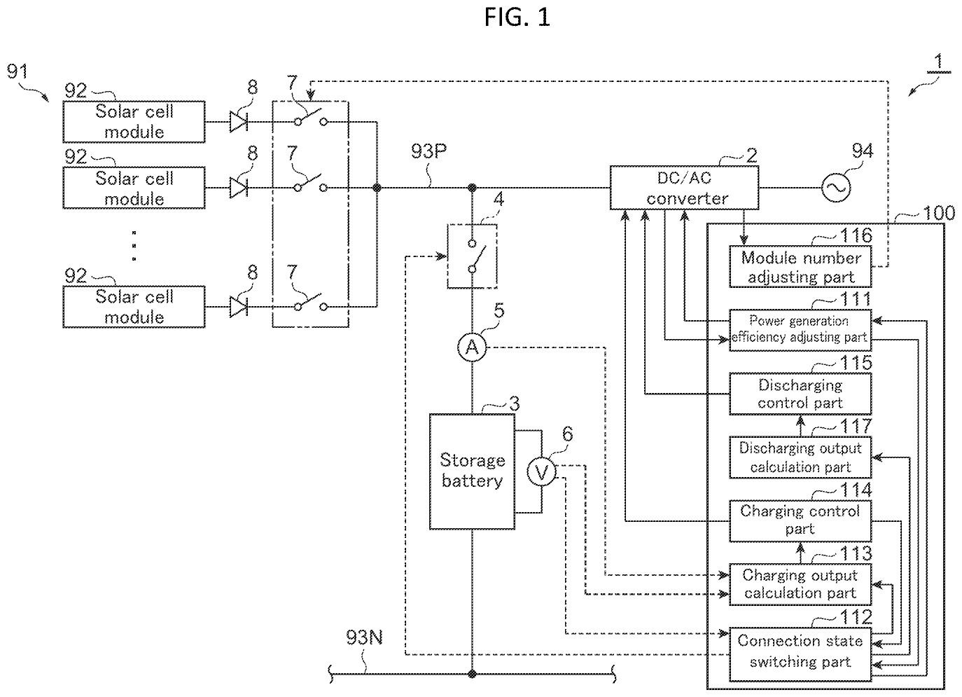

A power conditioning system 1 illustrated in FIG. 1 is a system that performs charging and discharging of power generated by a solar panel 91 and output to a power system 94. The solar panel 91 includes multiple solar cell modules 92. The multiple solar cell modules 92 each generate DC power according to an input of sunlight and output the generated DC power to common DC lines (93P, 93N). The solar cell modules 92 are connected to the DC lines (93P, 93N). However, in FIG. 1, wirings connecting the solar cell modules 92 to the DC line (93N) are omitted. Further, although not illustrated in the drawing, it is also possible that a negative electrode side of the solar panel 91 (the DC line (93N)) is grounded so that a potential of the solar panel 91 is a positive potential and a PID (potential induced degradation: voltage-induced output reduction) phenomenon of the solar cell modules 92 is suppressed. The power system 94 is a system that includes power generation equipment, power distribution equipment and power transmission equipment for an electric power company to supply AC power (for example, three-phase AC power) to electric power consumers.

The power conditioning system 1 includes a DC/AC converter 2, a storage battery 3, a charging and discharging switch 4, a current sensor 5, a voltage sensor 6, multiple disconnection switches 7, and a control device 100.

The DC/AC converter 2 is connected to the DC lines (93P, 93N), and converts DC power output from the solar panel 91 (from the multiple solar cell modules 92) into AC power and outputs the AC power to the power system 94. The DC/AC converter 2 is connected to the DC lines (93P, 93N). However, in FIG. 1, a wiring connecting the DC/AC converter 2 to the DC line (93N) is omitted. For example, the DC/AC converter 2 is a switching type power conditioner, and converts DC power into AC power by switching on or off multiple switching elements.

The storage battery 3 is connected to the DC lines (93P, 93N) between the solar panel 91 and the DC/AC converter 2 and stores the DC power output from the solar panel 91. Specific examples of the storage battery 3 include a lead battery, a lithium ion battery, and the like. The storage battery 3 may be a carbon foam battery. A carbon foam battery is a type of lead battery, and has a negative electrode formed of a carbon material.

The charging and discharging switch 4 switches between a state in which the storage battery 3 is connected to the DC lines (93P, 93N) and a state in which the storage battery 3 is disconnected from the DC lines (93P, 93N) according to an input of a control signal. The state in which the storage battery 3 is connected to the DC lines (93P, 93N) (hereinafter, this state is referred to as an “online state”) is a state in which at least charging or discharging is possible between the DC lines (93P, 93N) and the storage battery 3. The state in which the storage battery 3 is disconnected from the DC lines (93P, 93N) (hereinafter, this state is referred to as an “offline state”) is a state in which neither charging nor discharging is possible between the DC lines (93P, 93N) and the storage battery 3. Therefore, when the storage battery 3 is disconnected from at least one of the DC line (93P) and the DC line (93N), the offline state is achieved.

For example, the charging and discharging switch 4 is provided between the DC line (93P) and the storage battery 3, and switches between the online state and the offline state by switching connection and disconnection between the DC line (93P) and the storage battery 3. The DC line (93N) is always connected to the storage battery 3. It is also possible that the charging and discharging switch 4 is provided between the storage battery 3 and the DC line (93N). It is also possible that the charging and discharging switch 4 is structured such that the charging from the DC lines (93P, 93N) to the storage battery 3 and the discharging from the storage battery 3 to the DC lines (93P, 93N) can be individually turned on or off. For example, the charging and discharging switch 4 may have transistor switches that are connected in parallel in opposite directions between the DC line (93P) and the storage battery 3 or between the storage battery 3 and the DC line (93N) and can be individually turned on or off.

The current sensor 5 detects a current flowing between the storage battery 3 and the DC lines (93P, 93N). The voltage sensor 6 detects a voltage of the storage battery 3.

The multiple disconnection switches 7 respectively switch between a state in which the multiple solar cell modules 92 are connected to the DC lines (93P, 93N) and a state in which the multiple solar cell modules 92 are disconnected from the DC lines (93P, 93N). For example, the multiple disconnection switches 7 respectively intervene between the multiple solar cell modules 92 and the DC line (93P). The intervention here means an electrical intervention, and means that electric current paths between the solar cell modules 92 and the DC line (93P) are provided.

Each of the multiple disconnection switches 7 switches between a state in which a corresponding solar cell module 92 is connected to the DC line (93P) and a state in which the corresponding solar cell module 92 is disconnected from the DC line (93P) according to an input of a control signal. It is also possible that the multiple disconnection switches 7 respectively intervene between the solar cell modules 92 and the DC line (93N).

Multiple diodes 8 respectively prevent power backflow from the DC lines (93P, 93N) to the multiple solar cell modules 92. For example, the multiple diodes 8 respectively intervene between the multiple solar cell modules 92 and the DC line (93P). It is also possible that the multiple diodes 8 respectively intervene between the multiple solar cell modules 92 and the multiple disconnection switches 7, or between the multiple disconnection switches 7 and the DC line (93P). The multiple diodes 8 respectively prevent current backflow from the DC line (93P) to the solar cell modules 92.

It is also possible that the multiple diodes 8 respectively intervene between the multiple solar cell modules 92 and the DC line (93N). In this case, the multiple diodes 8 respectively prevent current backflow from the solar cell modules 92 to the DC line (93N).

The control device 100 adjusts an output (generated power) of the solar panel 91 by using the DC/AC converter 2. Here, in the power conditioning system 1 having the storage battery 3, charging power from the solar panel 91 to the storage battery 3 is also adjusted. However, when a power converter (for example, a DC/DC converter) is added for adjusting the charging power, the system structure becomes complicated. Further, power loss may occur in the added power converter.

Therefore, the control device 100 is structured to adjust the above-described charging power by using the DC/AC converter 2. For example, the control device 100 calculates a charging output based on a charging current from the DC lines (93P, 93N) to the storage battery 3 and a voltage of the storage battery 3, and causes an output of the DC/AC converter 2 to follow the charging output. As a result, the charging power to the storage battery 3 and the voltage of the storage battery 3 can be controlled using the DC/AC converter 2, and thus, the system structure can be simplified. Further, by omitting a power converter for adjusting the charging power, power loss in the power conditioning system 1 can be reduced.

For example, the control device 100 includes, as functional structural components (hereinafter referred to as “functional blocks”), a connection state switching part 112, a power generation efficiency adjusting part 111, a charging output calculation part 113, a charging control part 114, a discharging output calculation part 117, and a discharging control part 115.

The connection state switching part 112 causes the charging and discharging switch 4 to switch between the online state and the offline state based on at least a charging level of the storage battery 3. Further, the connection state switching part 112 sets a control mode of the DC/AC converter 2 in the online state to a charging mode or a discharging mode. The charging mode is a mode for controlling charging power from the DC lines (93P, 93N) to the storage battery 3, and the discharging mode is a mode for controlling discharging power from the storage battery 3 to the DC lines (93P, 93N).

For example, when the output of the solar panel 91 increases with sunrise and reaches a predetermined charging start level, the connection state switching part 112 switches the offline state to the online state and sets the control mode in the online state to the charging mode. After that, when the charging level of the storage battery 3 reaches a predetermined level, the connection state switching part 112 causes the charging and discharging switch 4 to switch the online state to the offline state.

The predetermined level may be a predetermined voltage value of the storage battery 3. In this case, when a voltage value detected by the voltage sensor 6 reaches a predetermined level, the connection state switching part 112 switches the online state to the offline state by using the charging and discharging switch 4.

The predetermined level may be defined during charging to the storage battery 3. As an example, when charging to the storage battery 3 is performed by constant current charging control and constant voltage charging control (to be described later), the predetermined level may be a predetermined duration of the constant voltage charging control. In this case, when the duration of the constant voltage charging control reaches a predetermined level, the connection state switching part 112 causes the charging and discharging switch 4 to switch the online state to the offline state.

After switching the online state to the offline state by the charging and discharging switch 4, the connection state switching part 112 causes the charging and discharging switch 4 to switch the offline state to the online state at a predetermined discharging start time, and sets the control mode in the online state to the discharging mode. The discharging start time is set to a time period during which a sufficient output from the solar panel 91 cannot be obtained. The discharging start time may be changed by a user input or may be automatically changed according to a change in sunshine duration. When the voltage of the storage battery 3 reaches a predetermined discharging stop voltage, the connection state switching part 112 causes the charging and discharging switch 4 to switch the online state to the offline state.

When the control mode in the online state is set to the charging mode, the charging output calculation part 113 calculates a charging output based on a charging current from the DC lines (93P, 93N) to the storage battery 3 and a voltage of the storage battery 3. For example, the charging output calculation part 113 performs a constant current charging calculation until a voltage of the storage battery 3 detected by the voltage sensor 6 reaches a predetermined control voltage, and performs a constant voltage charging calculation after the voltage of the storage battery 3 reaches the control voltage.

In the constant current charging calculation, the charging output calculation part 113 calculates a charging output so as to cause a charging current from the DC lines (93P, 93N) to the storage battery 3 to follow a predetermined target charging current. For example, the charging output calculation part 113 calculates an output change amount by subjecting a deviation between the target charging current and a current detected by the current sensor 5 (hereinafter, this current is referred to as the “current charging current”) to proportional calculation, proportional and integral calculation, proportional, integral and differential calculation, or the like, and calculates a new charging output by subtracting the calculated output change amount from the already calculated charging output. When the current charging current is smaller than the target charging current, the above output change amount is a positive value, and thus, a charging output smaller than the already calculated charging output is newly calculated. When the current charging current is larger than the target charging current, the output change amount is a negative value, and thus, a charging output larger than the calculated charging output is newly calculated.

In the constant voltage charging calculation, the charging output calculation part 113 calculates a charging output so as to cause the voltage of the storage battery 3 to follow a predetermined target voltage. For example, the charging output calculation part 113 calculates an output change amount by subjecting a deviation between the target voltage and a voltage detected by the voltage sensor 6 (hereinafter, this voltage is referred to as the “current voltage”) to proportional calculation, proportional and integral calculation, proportional, integral and differential calculation, or the like, and calculates a new charging output by subtracting the calculated output change amount from the already calculated charging output. When the current voltage is smaller than the target voltage, the above output change amount is a positive value, and thus, a charging output smaller than the already calculated charging output is newly calculated. When the current voltage is larger than the target voltage, the above output change amount is a negative value, and thus, a charging output larger than the already calculated charging output is newly calculated.

The control voltage may be determined, for example, based on a maximum power point of the solar panel 91. For example, the control voltage may be set to the same value as a voltage corresponding to the maximum power point. In this case, the output of the solar panel 91 during the constant voltage charging control can be maximized, and a large amount of surplus power can be output to the power system 94.

When the control mode in the online state is set to the charging mode, the charging control part 114 causes the output of the DC/AC converter 2 to follow the charging output calculated by the charging output calculation part 113. In this case, the charging control part 114 changes the output of the DC/AC converter 2 while causing the voltage of the DC lines (93P, 93N) to adapt to the voltage of the storage battery 3.

According to the charging output calculation part 113 and the charging control part 114, when the current charging current is less than the target charging current, the charging current supplied from the solar panel 91 to the storage battery 3 is increased by reducing the output of the DC/AC converter 2. When the current charging current is larger than the target charging current, the charging current supplied from the solar panel 91 to the storage battery 3 is reduced by increasing the output of the DC/AC converter 2.

Further, when the current voltage is smaller than the target voltage, the charging current supplied from the solar panel 91 to the storage battery 3 is increased by reducing the output of the DC/AC converter 2. As a result, the voltage of the storage battery 3 rises. Further, when the current voltage is larger than the target voltage, the charging current supplied from the solar panel 91 to the storage battery 3 is reduced by increasing the output of the DC/AC converter 2. As a result, the voltage of the storage battery 3 drops.

The discharging output calculation part 117 calculates a discharging output so as to cause a discharging current from the storage battery 3 to follow a predetermined target discharging current. For example, the discharging output calculation part 117 calculates an output change amount by subjecting a deviation between the target discharging current and a current detected by the current sensor 5 (hereinafter, this current is referred to as the “current discharging current”) to proportional calculation, proportional and integral calculation, proportional, integral and differential calculation, or the like, and calculates a new discharging output by subtracting the calculated output change amount from the already calculated discharging output. When the current discharging current is smaller than the target discharging current, the output change amount is a positive value, and thus, a discharging output larger than the already calculated discharging output is newly calculated. When the current discharging current is larger than the target discharging current, the output change amount is a negative value, and thus, a discharging output smaller than the already calculated discharging output is newly calculated.

When the control mode in the online state is set to the discharging mode, the discharging control part 115 causes the output of the DC/AC converter 2 to follow the discharging output calculated by the discharging output calculation part 117. In this case, the discharging control part 115 changes the output of the DC/AC converter 2 while causing the voltage of the DC lines (93P, 93N) to adapt to the voltage of the storage battery 3.

The power generation efficiency adjusting part 111, in the offline state, changes the output of the solar panel 91 by using the DC/AC converter 2. For example, the power generation efficiency adjusting part 111 changes the output of the solar panel 91 by changing the voltage of the DC lines (93P, 93N) by using the DC/AC converter 2. As an example, the control device 100 performs MPPT (Maximum Power Point Tracking) control. Specifically, the DC/AC converter 2 is controlled so as to cause the voltage of the DC lines (93P, 93N) to follow the maximum power point.

As a result of the MPPT control, when the output of the DC/AC converter 2 exceeds a predetermined upper limit, the control device 100 suppresses the output of the DC/AC converter 2 to the upper limit or lower by changing the voltage of the DC lines (93P, 93N). The upper limit is set in advance based on, for example, a rated voltage of the DC/AC converter 2. For example, the power generation efficiency adjusting part 111 controls the DC/AC converter 2 so as to keep the voltage of the DC lines (93P, 93N) away from the maximum power point until the output from the solar panel 91 falls below the upper limit.

Here, in the online state, since the voltage of the DC lines (93P, 93N) is restricted by the voltage of the storage battery 3, the voltage of the DC lines (93P, 93N) cannot be freely changed by the DC/AC converter 2. Therefore, the control device 100 may further include a module number adjusting part 116.

The module number adjusting part 116 changes the output of the solar panel 91 by causing the multiple disconnection switches 7 to change the number of the solar cell modules 92 connected to the DC lines (93P, 93N) in the online state. For example, when the output of the DC/AC converter 2 reaches the upper limit, the module number adjusting part 116 causes at least one of the multiple disconnection switches 7 to disconnect at least one of the multiple solar cell modules 92 from the DC lines (93P, 93N).

The module number adjusting part 116 may calculate an output reduction amount based on a current output and the upper limit of the DC/AC converter 2 and determine the number of the disconnection switches 7 to be disconnected from the DC lines (93P, 93N) based on the output reduction amount.

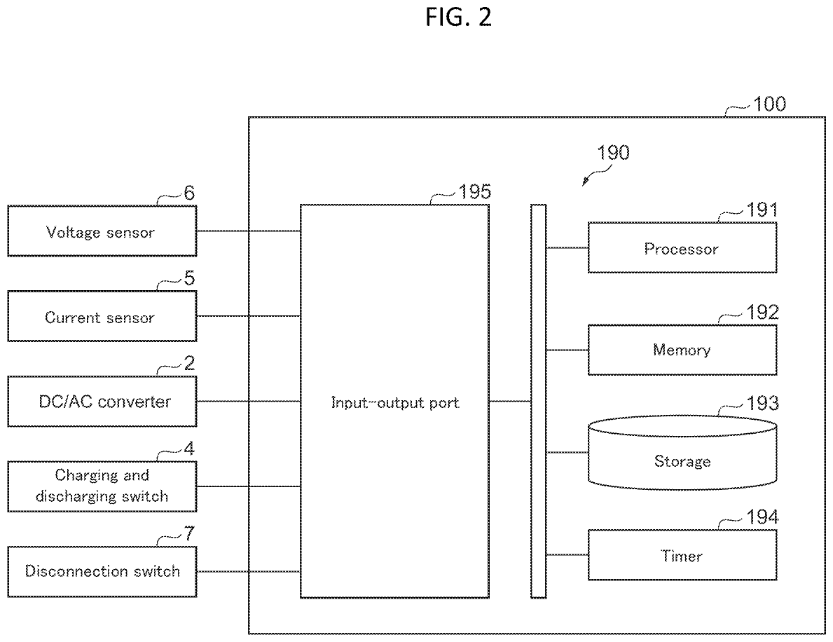

FIG. 2 illustrates a hardware structure of the control circuit 100. The control device 100 is a control computer such as a programmable logic controller, and includes a circuit 190. The circuit 190 includes one or more processors 191, a memory 192, a storage 193, a timer 194, and an input-output port 195.

For example, the storage 193 is at least a memory medium such as a hard disk or a non-volatile memory. The storage 193 stores a program that causes the control device 100 to execute a control method that includes calculating the charging output based on the charging current to the storage battery 3 and the voltage of the storage battery 3, and causing the output of the DC/AC converter 2 to follow the charging output. For example, the storage 193 stores a program for forming the above-described functional blocks in the control device 100.

The memory 192 temporarily stores, for example, a program loaded from the storage 193 and a calculation result of the processor 191. The processor 191 executes the above-described program in cooperation with the memory 192. The timer 194 measures a time by counting clock pulses. The input-output port 195 performs input or output of an electric signal to or from the DC/AC converter 2, the charging and discharging switch 4, the current sensor 5, the voltage sensor 6 or the disconnection switches 7 according to a command from the processor 191.

The control device 100 is not necessarily limited to a device that uses a program to achieve the functions. For example, the control circuit 100 may achieve at least some of the functions using a dedicated logic circuit or an ASIC (Application Specific Integrated Circuit) that integrates the logic circuit.

### Control Procedure

Next, as an example of the control method, a control procedure to be executed by the control device 100 is described. The control procedure includes a charging control procedure of the storage battery 3, an output control procedure of the solar panel 91, and a discharging control procedure of the storage battery 3. Each of the procedures is repeatedly executed each time an execution condition thereof is met. In the following, the procedures are each described in detail.

### Charging Control Procedure

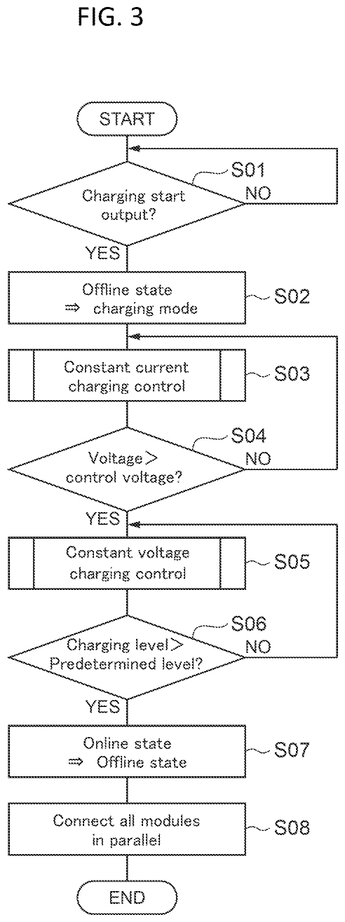

This procedure includes calculating a charging output based on the charging current to the storage battery 3 and the voltage of the storage battery 3, and causing the output of DC/AC converter 2 to follow the charging output. As illustrated in FIG. 3, the control device 100 first executes Steps S01, S02, S03, and S04. In Step S01, the connection state switching part 112 waits for the output of the solar panel 91 to increase with sunrise and reach a predetermined charging start level while keeping the charging and discharging switch 4 in the offline state.

In Step S02, the connection state switching part 112 causes the charging and discharging switch 4 to switch the offline state to the online state, and sets the control mode in the online state to the charging mode. In Step S03, the charging output calculation part 113 and the charging control part 114 perform constant current charging control. The specific content of Step S03 will be described later. In Step S04, the charging output calculation part 113 confirms whether or not the voltage of storage battery 3 (the voltage detected by the voltage sensor 6) has reached the above-described control voltage.

When it is determined in Step S04 that the voltage of the storage battery 3 has not reached the control voltage, the control device 100 returns the process to Step S03. After that, the constant current charging control is repeated until the voltage of the storage battery 3 reaches the control voltage.

When it is determined in Step S04 that the voltage of the storage battery 3 has reached the control voltage, the control device 100 executes Steps S05 and S06. In Step S05, the charging output calculation part 113 and the charging control part 114 perform constant voltage charging control. The specific content of Step S05 will be described later. In Step S06, the connection state switching part 112 confirms whether or not the charging level of the storage battery 3 has reached the above-described predetermined level.

When it is determined in Step S06 that the charging level of the storage battery 3 has not reached the predetermined level, the control device 100 returns the process to Step S05. After that, the constant voltage charging control is repeated until the charging level of the storage battery 3 reaches the predetermined level.

When it is determined in Step S06 that the charging level of the storage battery 3 has reached the predetermined level, the control device 100 executes Steps S07 and S08. In Step S07, the connection state switching part 112 causes the charging and discharging switch 4 to switch the online state to the offline state. In Step S08, when there is a solar cell module 92 that has been disconnected from the DC lines (93P, 93N) by any one of the multiple disconnection switches 7, the connection state switching part 112 causes the multiple disconnection switches 7 to connect all the solar cell modules 92 to the DC lines (93P, 93N). As a result, the charging control procedure is completed.

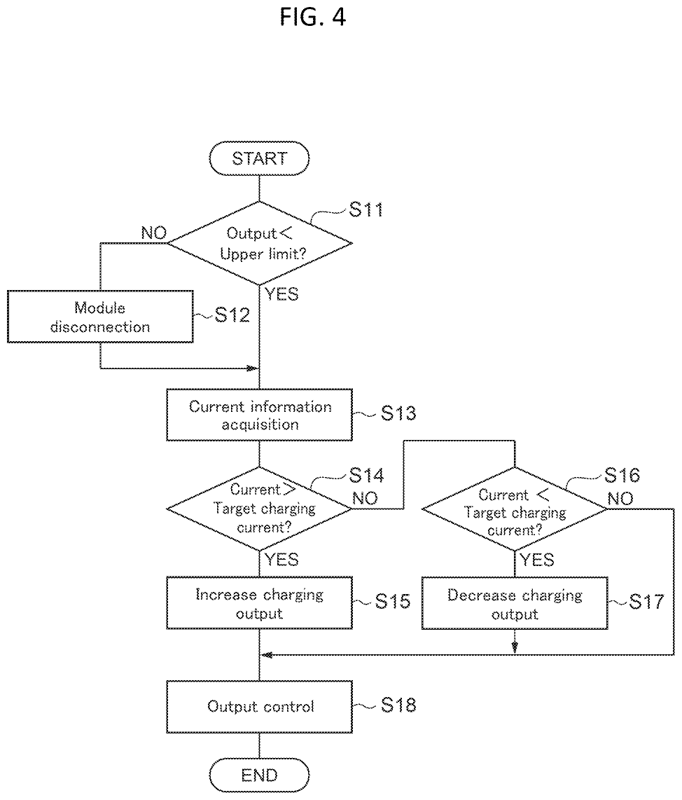

FIG. 4 is a flowchart illustrating the constant current charging control procedure in Step S03. As illustrated in FIG. 4, the control device 100 first executes Step S11. In Step S11, the module number adjusting part 116 confirms whether or not the output of the DC/AC converter 2 is below the above-described upper limit.

When it is determined in Step S11 that the output of the DC/AC converter 2 is equal to or greater than the upper limit, the control device 100 executes Step S12. In Step S12, the module number adjusting part 116 causes at least one of the multiple disconnection switches 7 to disconnect at least one of the multiple solar cell modules 92 from the DC lines (93P, 93N) such that the output of the DC/AC converter 2 is below the above-described upper limit.

Next, the control device 100 executes Steps S13 and S14. When it is determined in Step S11 that the output of the DC/AC converter 2 is below the upper limit, the control device 100 executes Steps S13 and S14 without executing Step S12. In Step S13, the charging output calculation part 113 acquires the current detected by the current sensor 5 (the above-described current charging current). In Step S14, the charging output calculation part 113 confirms whether or not the current charging current exceeds the target charging current.

When it is determined in Step S14 that the current charging current exceeds the target charging current, the control device 100 executes Step S15. In Step S15, the charging output calculation part 113 calculates the above-described output change amount based on a deviation between the target charging current and the current charging current, and increases the charging output by subtracting the calculated output change amount from the already calculated charging output.

When it is determined in Step S14 that the current charging current does not exceed the target charging current, the control device 100 executes Step S16. In Step S16, the charging output calculation part 113 confirms whether or not the current charging current is less than the target charging current.

When it is determined in Step S16 that the current charging current is less than the target charging current, the control device 100 executes Step S17. In Step S17, the charging output calculation part 113 calculates the above-described output change amount based on a deviation between the target charging current and the current charging current, and decreases the charging output by subtracting the calculated output change amount from the already calculated charging output.

After Steps S15 and S17, the control device 100 executes Step S18. When it is determined in Step S16 that the current charging current is not less than the target charging current, the control device 100 executes Step S18 without executing Steps S15 and S17. In Step S18, the charging control part 114 causes the output of the DC/AC converter 2 to follow the charging output calculated by the charging output calculation part 113. As a result, the constant current charging control procedure is completed.

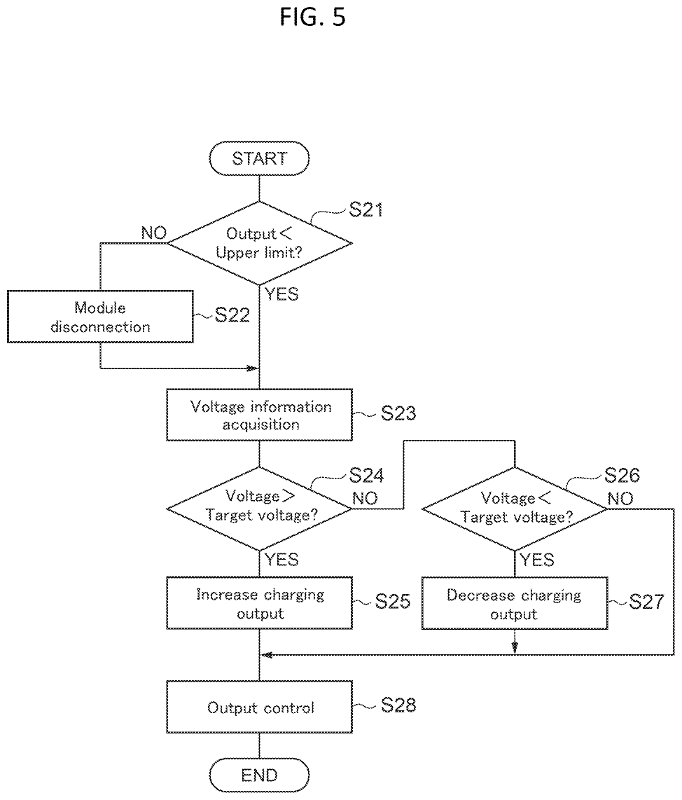

FIG. 5 is a flowchart illustrating the constant voltage charging control procedure in Step S05. As illustrated in FIG. 5, the control device 100 first executes Step S21. In Step S21, the module number adjusting part 116 confirms whether or not the output of the DC/AC converter 2 is below the above-described upper limit.

When it is determined in Step S21 that the output of the DC/AC converter 2 is equal to or greater than the upper limit, the control device 100 executes Step S22. In Step S22, the module number adjusting part 116 causes at least one of the multiple disconnection switches 7 to disconnect at least one of the multiple solar cell modules 92 from the DC lines (93P, 93N) such that the output of the DC/AC converter 2 is below the above-described upper limit.

Next, the control device 100 executes Steps S23 and S24. When it is determined in Step S21 that the output of the DC/AC converter 2 is below the upper limit, the control device 100 executes Steps S23 and S24 without executing Step S22. In Step S23, the charging output calculation part 113 acquires the voltage detected by the voltage sensor 6 (the above-described current voltage). In Step S24, the charging output calculation part 113 confirms whether or not the current voltage exceeds the target voltage.

When it is determined in Step S24 that the current voltage exceeds the target voltage, the control device 100 executes Step S25. In Step S25, the charging output calculation part 113 calculates the above-described output change amount based on a deviation between the target voltage and the current voltage, and increases the charging output by subtracting the calculated output change amount from the already calculated charging output.

When it is determined in Step S24 that the current voltage does not exceed the target voltage, the control device 100 executes Step S26. In Step S26, the charging output calculation part 113 confirms whether or not the current voltage is less than the target voltage.

When it is determined in Step S26 that the current voltage is less than the target voltage, the control device 100 executes Step S27. In Step S27, the charging output calculation part 113 calculates the above-described output change amount based on a deviation between the target voltage and the current voltage, and decreases the charging output by subtracting the calculated output change amount from the already calculated charging output.

After Steps S25 and S27, the control device 100 executes Step S28. When it is determined in Step S26 that the current voltage is not less than the target voltage, the control device 100 executes Step S28 without executing Steps S25 and S27. In Step S28, the charging control part 114 causes the output of the DC/AC converter 2 to follow the charging output calculated by the charging output calculation part 113. As a result, the constant voltage charging control procedure is completed.

### Output Control Procedure

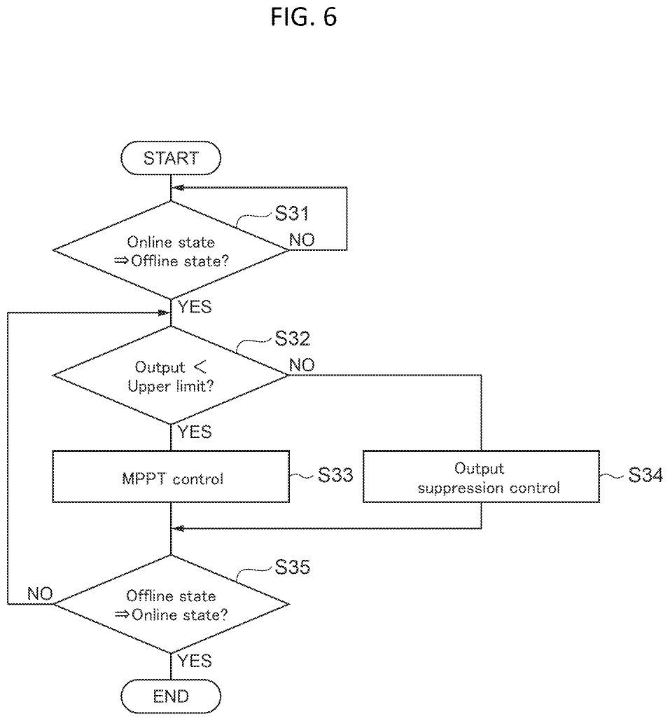

As illustrated in FIG. 6, the control device 100 first executes Steps S31 and S32. In Step S31, the power generation efficiency adjusting part 111 waits for the online state to be switched to the offline state by the charging and discharging switch 4. In Step S32, the power generation efficiency adjusting part 111 confirms whether or not the output of the DC/AC converter 2 is below the above-described upper limit.

When it is determined in Step S32 that the output of the DC/AC converter 2 is below the upper limit, the control device 100 executes Step S33. In Step S33, the power generation efficiency adjusting part 111 controls the DC/AC converter 2 so as to cause the voltage of the DC lines (93P, 93N) to follow the maximum power point.

When it is determined in Step S32 that the output of the DC/AC converter 2 is not below the upper limit, the control device 100 executes Step S34. In Step S34, the power generation efficiency adjusting part 111 controls the DC/AC converter 2 so as to keep the voltage of the DC lines (93P, 93N) away from the maximum power point until the output from the solar panel 91 falls below the upper limit.

After Steps S33 and S34, the control device 100 executes Step S35. In Step S35, the power generation efficiency adjusting part 111 confirms whether or not the offline state has been switched to the online state by the charging and discharging switch 4.

When it is determined in Step S35 that the offline state has not been switched to the online state by the charging and discharging switch 4, the control device 100 returns the process to Step S32. After that, the output adjustment of the solar panel 91 by the DC/AC converter 2 is repeated until the offline state is switched to the online state by the charging and discharging switch 4.

When in Step S35 the offline state has been switched to the online state by the charging and discharging switch 4, the output control procedure of the solar panel 91 is completed.

### Discharging Control Procedure

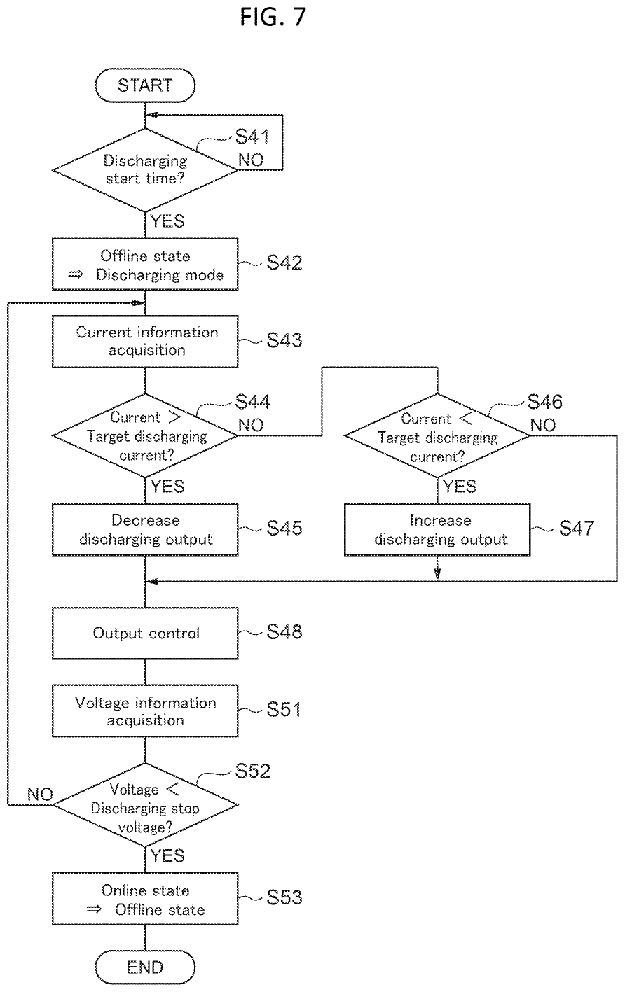

As illustrated in FIG. 7, the control device 100 first executes Steps S41, S42, S43, and S44. In Step S41, the connection state switching part 112 waits for a discharging start time. In Step S42, the connection state switching part 112 causes the charging and discharging switch 4 to switch the offline state to the online state, and sets the control mode in the online state to the discharging mode. In Step S43, the discharging output calculation part 117 acquires the current detected by the current sensor 5 (the above-described current discharging current). In Step S44, the discharging output calculation part 117 confirms whether or not the current discharging current exceeds the target discharging current.

When it is determined in Step S44 that the current discharging current exceeds the target discharging current, the control device 100 executes Step S45. In Step S45, the discharging output calculation part 117 calculates the above-described output change amount based on a deviation between the target discharging current and the current discharging current, and decreases the discharging output by adding the calculated output change amount to the already calculated discharging output.

When it is determined in Step S44 that the current discharging current does not exceed the target discharging current, the control device 100 executes Step S46. In Step S46, the discharging output calculation part 117 confirms whether or not the current discharging current is less than the target discharging current.

When it is determined in Step S46 that the current discharging current is less than the target discharging current, the control device 100 executes Step S47. In Step S47, the discharging output calculation part 117 calculates the above-described output change amount based on a deviation between the target discharging current and the current discharging current, and increases the discharging output by adding the calculated output change amount to the already calculated discharging output.

After Steps S45 and S47, the control device 100 executes Steps S48, S51, and S52. When it is determined in Step S46 that the current discharging current is not less than the target discharging current, the control device 100 executes Steps S48, S51 and S52 without executing Steps S45 and S47. In Step S48, the discharging control part 115 causes the output of the DC/AC converter 2 to follow the discharging output calculated by the discharging output calculation part 117. In Step S51, the connection state switching part 112 acquires a voltage detected by the voltage sensor 6 (hereinafter, this voltage is referred to as the “current voltage”). In Step S52, the connection state switching part 112 confirms whether or not the current voltage has reached the above-described discharging stop voltage.

When it is determined in Step S52 that the current voltage has not reached the discharging stop voltage, the control device 100 returns the process to Step S43. After that, until the current voltage reaches the discharging stop voltage, the control for causing the discharging current to follow the target discharging current is repeated.

When it is determined in Step S52 that the current voltage has reached the discharging stop voltage, the control device 100 executes Step S53. In Step S53, the connection state switching part 112 causes the charging and discharging switch 4 to switch the online state to the offline state. As a result, the discharging control procedure is completed.

As described above, the power conditioning system 1 includes: the DC/AC converter 2 that is connected to the DC lines (93P, 93N) to which the DC power from the solar panel 91 is output, converts the DC power to AC power and outputs the AC power; the storage battery 3 that is connected to the DC lines (93P, 93N) and stores the DC power; and the control device 100 that calculates a charging output based on a charging current from the DC lines (93P, 93N) to the storage battery 3 and a voltage of the storage battery 3 and causes the output of the DC/AC converter 2 to follow the charging output.

According to the power conditioning system 1, the charging current to the storage battery 3 and the voltage of the storage battery 3 can be controlled by using the DC/AC converter 2 that converts the DC power to the AC power and outputs the AC power. Therefore, it is effective in structural simplification. Further, by using the DC/AC converter 2 to control the charging current to the storage battery 3 and the voltage of the storage battery 3, a power conversion device dedicated to charging control can be omitted and power loss associated with power conversion can be reduced.

The control device 100 may calculate the charging output so as to cause a charging current from the DC lines (93P, 93N) to the storage battery 3 to follow a predetermined target charging current until the voltage of the storage battery 3 reaches a predetermined control voltage, and, after the voltage of the storage battery 3 reaches the control voltage, calculate the charging output so as to cause the voltage of the storage battery 3 to follow the control voltage. In this case, both constant current charging control and constant voltage charging control can be performed using the DC/AC converter 2. Therefore, it is more effective in structural simplification.

The control device 100 may calculate the discharging output so as to cause a discharging current from the storage battery 3 to follow a predetermined target discharging current, and may cause an output of the DC/AC converter 2 to follow the discharging output. In this case, the discharging current of the storage battery 3 can also be controlled using the DC/AC converter 2. Therefore, it is more effective in structural simplification.

The power conditioning system 1 may further include the charging and discharging switch 4 that switches between the online state in which the storage battery 3 is connected to the DC lines (93P, 93N) and the offline state in which the storage battery 3 is disconnected from the DC lines (93P, 93N). The control device 100 may cause the charging and discharging switch 4 to switch between the online state and the offline state based on at least a charging level of the storage battery 3. In this case, the degree of freedom of the control of the DC/AC converter 2 can be increased by disconnecting the storage battery 3 from the DC lines (93P, 93N) during a time period in which charging or discharging to or from the storage battery 3 is unnecessary.

The control device 100 may cause the charging and discharging switch 4 to switch the online state to the offline state when the charging level of the storage battery 3 has reached a predetermined level, and may cause the charging and discharging switch 4 to switch the offline state to the online state at a predetermined discharging start time. In this case, it is possible to easily automate the disconnection of the storage battery 3 from the DC lines during a time period in which charging or discharging to or from the storage battery 3 is unnecessary.

The control device 100, in the online state, may change the output of the DC/AC converter 2 while causing the voltage of the DC lines (93P, 93N) to adapt to the voltage of the storage battery 3, and, in the offline state, may change the output of the solar panel 91 by changing the voltage of the DC lines (93P, 93N). In this case, by disconnecting the storage battery 3 from the DC lines (93P, 93N), the DC/AC converter 2 can be effectively used in suppressing the output of the solar panel 91.

The power conditioning system 1 may further include the multiple disconnection switches 7 that respectively intervene between the multiple solar cell modules 92 of the solar panel 91 and the DC lines (93P, 93N), and the control device 100, in the online state, may change the output of the solar panel 91 by causing the multiple disconnection switches 7 to change the number of the solar cell modules 92 connected to the DC lines (93P, 93N). In this case, even in the online state in which the voltage of the DC lines (93P, 93N) cannot be freely changed, the output of the solar panel 91 can be easily suppressed by switching the disconnection switches 7 from on to off.

A power conditioning system according to an embodiment of the present invention is effective in structural simplification.

A power conditioning system according to one aspect of the present invention includes: a DC/AC converter that is connected to a DC line to which DC power from a solar panel is output, and converts the DC power to AC power and outputs the AC power; a storage battery that is connected to the DC line and stores the DC power; and a control device that calculates a charging output based on a charging current from the DC line to the storage battery and a voltage of the storage battery, and causes an output of the DC/AC converter to follow the charging output.

A control device according to another aspect of the present invention calculates a charging output based on a charging current to a storage battery and a voltage of the storage battery, the storage battery being connected to a DC line to which DC power from a solar panel is input and storing the DC power, and causes an output of a DC/AC converter to follow the charging output, the DC/AC converter being connected to the DC line and converting the DC power to AC power and outputting the AC power.

A control method according to yet other aspect of the present invention is to be executed by a control device and includes: calculating a charging output based on a charging current to a storage battery and a voltage of the storage battery, the storage battery being connected to a DC line to which DC power from a solar panel is input and storing the DC power; and causing an output of a DC/AC converter to follow the charging output, the DC/AC converter being connected to the DC line and converting the DC power to AC power and outputting the AC power.

Obviously, numerous modifications and variations of the present invention are possible in light of the above teachings. It is therefore to be understood that within the scope of the appended claims, the invention may be practiced otherwise than as specifically described herein.

What is claimed is:

1. A power conditioning system, comprising:
a DC/AC converter connected to a DC line to which DC power from a solar panel is output such that the DC/AC converter is configured to convert the DC power to AC power and output the AC power;
a storage battery connected to the DC line and configured to store the DC power; and
a control circuit configured to calculate a charging output based on a charging current between the DC line and the storage battery and on a voltage of the storage battery, and cause an output of the DC/AC converter to correspond to the charging output.

2. The power conditioning system according to claim 1, wherein the control circuit is further configured to calculate the charging output to cause a charging current between the DC line and the storage battery to correspond to a predetermined target charging current until the voltage of the storage battery reaches a predetermined control voltage, and calculate, after the voltage of the storage battery reaches the control voltage, the charging output to cause the voltage of the storage battery to correspond to the control voltage.

3. The power conditioning system according to claim 1, wherein the control circuit is further configured to calculate a discharging output such that a discharging current from the storage battery corresponds to a predetermined target discharging current, and cause an output of the DC/AC converter to correspond to the discharging output.

4. The power conditioning system according to claim 1, further comprising:
a charging and discharging switch configured to switch between an online state in which the storage battery is connected to the DC line and an offline state in which the storage battery is disconnected from the DC line,
wherein the control circuit is further configured to cause the charging and discharging switch to switch between the online state and the offline state based on at least a charging level of the storage battery.

5. The power conditioning system according to claim 4, wherein the control circuit is further configured to cause the charging and discharging switch to switch from the online state to the offline state when the charging level of the storage battery has reached a predetermined level, and cause the charging and discharging switch to switch from the offline state to the online state at a predetermined discharging start time.

6. The power conditioning system according to claim 4, wherein the control circuit is further configured to change, in the online state, the output of the DC/AC converter while causing a voltage of the DC line to adapt to the voltage of the storage battery, and change, in the offline state, an output of the solar panel by changing the voltage of the DC line.

7. The power conditioning system according to claim 6, further comprising:
a plurality of disconnection switches each configured to respectively intervene between a plurality of modules of the solar panel and the DC line,
wherein the control circuit is further configured to, in the online state, change the output of the solar panel by changing a number of the modules connected to the DC line using the plurality of disconnection switches.

8. The power conditioning system according to claim 2, wherein the control circuit is further configured to calculate a discharging output such that a discharging current from the storage battery corresponds to a predetermined target discharging current, and cause an output of the DC/AC converter to correspond to the discharging output.

9. The power conditioning system according to claim 2, further comprising:
a charging and discharging switch configured to switch between an online state in which the storage battery is connected to the DC line and an offline state in which the storage battery is disconnected from the DC line,
wherein the control circuit is further configured to cause the charging and discharging switch to switch between the online state and the offline state based on at least a charging level of the storage battery.

10. The power conditioning system according to claim 3, further comprising:
a charging and discharging switch configured to switch between an online state in which the storage battery is connected to the DC line and an offline state in which the storage battery is disconnected from the DC line,
wherein the control circuit is further configured to cause the charging and discharging switch to switch between the online state and the offline state based on at least a charging level of the storage battery.

11. The power conditioning system according to claim 5, wherein the control circuit is further configured to change, in the online state, the output of the DC/AC converter while causing a voltage of the DC line to adapt to the voltage of the storage battery, and change, in the offline state, an output of the solar panel by changing the voltage of the DC line.

12. A control method implemented by a control device, comprising:
calculating a charging output based on a charging current between a DC line and a storage battery and on a voltage of the storage battery; and
causing an output of a DC/AC converter to correspond to the charging output,
wherein the storage battery is connected to the DC line to which DC power from a solar panel is input, the storage battery is configured to store the DC power, and the DC/AC converter is connected to the DC line and configured to convert the DC power to AC power and to output the AC power.

13. The control method according to claim 12, further comprising:
calculating a discharging output such that a discharging current from the storage battery corresponds to a predetermined target discharging current; and
causing an output of the DC/AC converter to correspond to the discharging output.

14. A control device, comprising:
a control circuit configured to calculate a charging output based on a charging current input into a storage battery and on a voltage of the storage battery, and cause an output of a DC/AC converter to correspond to the charging output,
wherein the storage battery is connected to a DC line to which DC power from a solar panel is input such that the storage battery is configured to store the DC power, and the DC/AC converter is connected to the DC line and configured to convert the DC power to AC power and to output the AC power.

15. The control device according to claim 14, wherein the control circuit is further configured to calculate a discharging output such that a discharging current from the storage battery corresponds to a predetermined target discharging current, and cause an output of the DC/AC converter to correspond to the discharging output.

16. The control device according to claim 14, wherein the control circuit is further configured to calculate the charging output to cause a charging current between the DC line and the storage battery to correspond to a predetermined target charging current until the voltage of the storage battery reaches a predetermined control voltage, and calculate, after the voltage of the storage battery reaches the control voltage, the charging output to cause the voltage of the storage battery to correspond to the control voltage.

17. The control device according to claim 14, wherein the control circuit is further configured to cause a charging and discharging switch to switch between an online state in which the storage battery is connected to the DC line and an offline state in which the storage battery is disconnected from the DC line based on at least a charging level of the storage battery.

18. The control device according to claim 17, wherein the control circuit is further configured to cause the charging and discharging switch to switch from the online state to the offline state when the charging level of the storage battery has reached a predetermined level, and cause the charging and discharging switch to switch from the offline state to the online state at a predetermined discharging start time.

19. The control device according to claim 17, wherein the control circuit is further configured to change, in the online state, the output of the DC/AC converter while causing a voltage of the DC line to adapt to the voltage of the storage battery, and change, in the offline state, an output of the solar panel by changing the voltage of the DC line.

20. The control device according to claim 19, wherein the control circuit is further configured to, in the online state, change the output of the solar panel by changing a number of modules connected to the DC line using a plurality of disconnection switches each configured to respectively intervene between a plurality of modules of the solar panel and the DC line.
